(19) United States
(12) Patent Application Publication
(10) Pub. No.: US 2010/0139132 A1
(43) Pub. Date: Jun. 10, 2010

(54) Sports Luggage Tags

(76) Inventor: Lisa Kasten, Plantation, FL (US)

Correspondence Address: ROBERT M. SCHWARTZ, P.A., P.O. BOX 221470, HOLLYWOOD, FL, 33022, US

(21) Appl. No.: 12/706,290

(22) Filed: Feb. 16, 2010

Related U.S. Application Data
(63) Continuation-in-part of application No. 12/201,324, filed on Aug. 29, 2008.
(60) Provisional application No. 60/969,288, filed on Aug. 31, 2007.

(51) Int. Cl. G09F 3/20

(52) U.S. Cl. 40/6

(57) ABSTRACT

A luggage tag for providing identifying indicia having a front and a back panel, at least the outer surface of the front panel having features to realistically visually and tactilely imitate and resemble an article, a back panel having attached thereto a substantially transparent pocket suitable for holding and viewing identifying indicia of the owner of the luggage to which the tag is attached.

### INDEX TO RELATED APPLICATIONS

This application is a continuation-in-part of U.S. patent application Ser. No. 12/201,324, filed Aug. 29, 2008, which claims the benefit of U.S. Provisional Application 60/969,288 filed Aug. 31, 2007 the disclosures of which are incorporated herein by reference in their entirety.

### BRIEF SUMMARY OF THE INVENTION

The present invention is a novel identifying luggage tag. The tag comprises at least two substrates that are connected. The outer portion of at least one of the substrates has surface features to create a realistic appearance and texture of a desired article. The realistic appearance and texture may be of any desired article. In some preferred embodiments the desired article may include a baseball, a basketball, a football, a tennis ball, a hockey puck, and the like. It is preferred, that the realistic appearance and texture has the look and feel of the article selected. For example, in an article selected to resemble a baseball, the appearance and texture is the white leather and characteristic red stitching of a baseball. The depiction of the desired article is formed with similar or identical materials used in the manufacture of the actual article. For example, if the desired article is a tennis ball, actual or simulated tennis ball felt is used as the outer substrate of the luggage tag to create the look and feel of an actual tennis ball. The present invention is not intended to be limited to displaying the appearance of baseballs, tennis balls, and the like, but, may be used to show the realistic depiction of any desired article.

The luggage tag includes a back panel having a substantially transparent pocket for a user to insert identifying indicia or information for identification of the owner of the luggage to which the tag is attached. The identifying indicia would include the name and address of the owner of the luggage or other article to which the tag is attached. The identifying indicia may also be electronic and or computer readable information identifying the owner and or destination of the article to which the novel identifying luggage tag is attached. In one embodiment, the identifying indicia may also include information applied directly to the tag. This may be printed or embedded into the tag or applied with a label adhered to the tag.

The luggage tag will have at least one slot that is used for attaching a string, rope, belt, strap, tether, and the like to the tag and further securing the tag to a desired article for identification.

### BRIEF DESCRIPTION OF THE DRAWINGS

FIG. 1 is a front view of an embodiment of the invention.

FIG. 2 is a side view of the embodiment of FIG. 1.

FIG. 3 is a rear view of the embodiment of FIG. 1.

FIG. 4 is a front view of another embodiment of the invention.

FIG. 5 is a side view of the embodiment of FIG. 4.

FIG. 6 is a rear view of the embodiment of FIG. 4.

FIG. 7 is a front view of another embodiment of the invention.

FIG. 8 is a side view of the embodiment of FIG. 7.

FIG. 9 is a rear view of the embodiment of FIG. 7.

FIG. 10 is a front view of another embodiment of the invention.

FIG. 11 is a side view of the embodiment of FIG. 10.

FIG. 12 is a rear view of the embodiment of FIG. 10.

FIG. 13 is a perspective exploded view of the embodiment of FIG. 7 of the invention.

FIG. 14 is a sectional view of the embodiment of FIG. 4 of the invention, shown for clarity without the relief and texture.

FIG. 15 is a side sectional view of the embodiment of FIG. 7 of the invention, shown for clarity without the relief and texture.

### DETAILED DESCRIPTION OF THE PREFERRED EMBODIMENTS

Luggage tag 10 has a front panel 11 (identified in the several embodiments with a letter e.g. 11A, 11B, 11C etc.), and a back panel 12. Front panel 11 and back panel 12 are secured one to another by peripheral stitching 14. A tether strap 13 passes through luggage tag 10 at slot 15. A display compartment 16 is attached to the outer back panel 12 and forms a display compartment 17 for holding an identification tag 20. Display compartment 16 is attached to panel 12 by stitching 21.

Luggage tag 10 has an interior portion having a first rigid support 24, a second rigid support 25, and padding 26 positioned between front panel 11 and back panel 12.

Each front panel 11, as disclosed herein, has surface indicia features to realistically tactilely imitate an article. The examples disclosed herein of surface indicia features to realistically tactilely imitate an article are meant to be illustrative and in no way limit the invention.

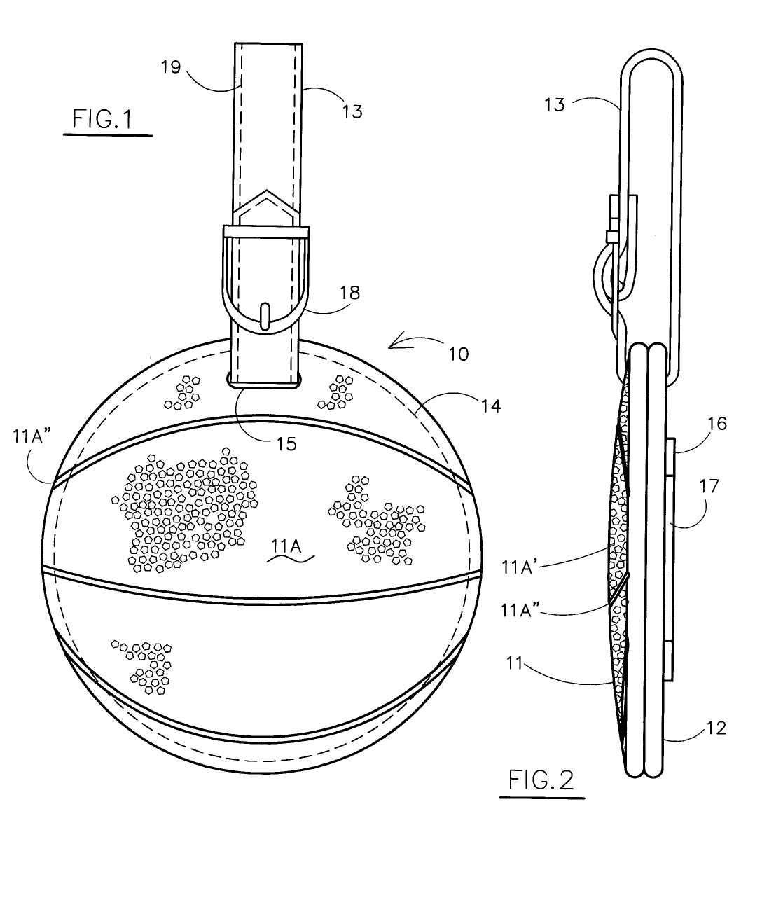

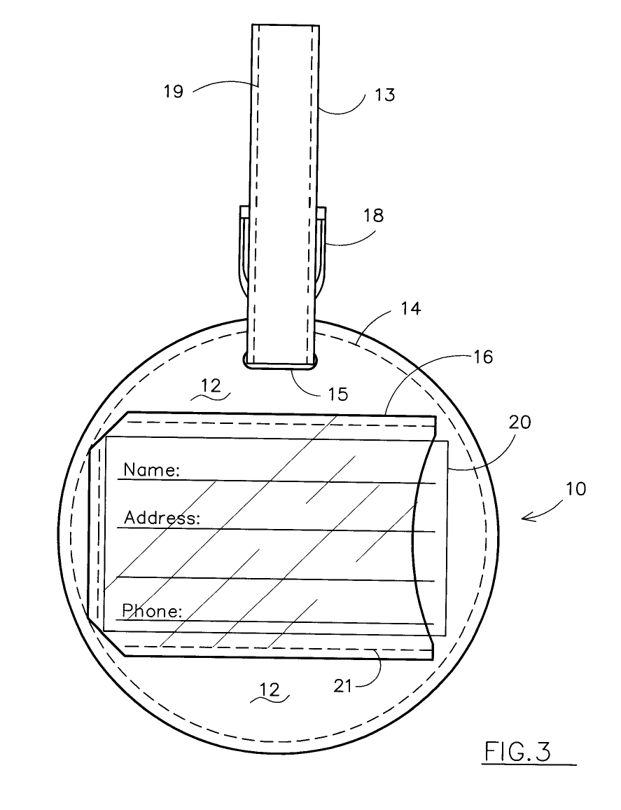

As seen in FIGS. 1 and 2, front panel 11A has surface indicia constructed and arranged to look and feel like a basketball, with a textured pebbled surface 11A′ and indented ribs 11A″.

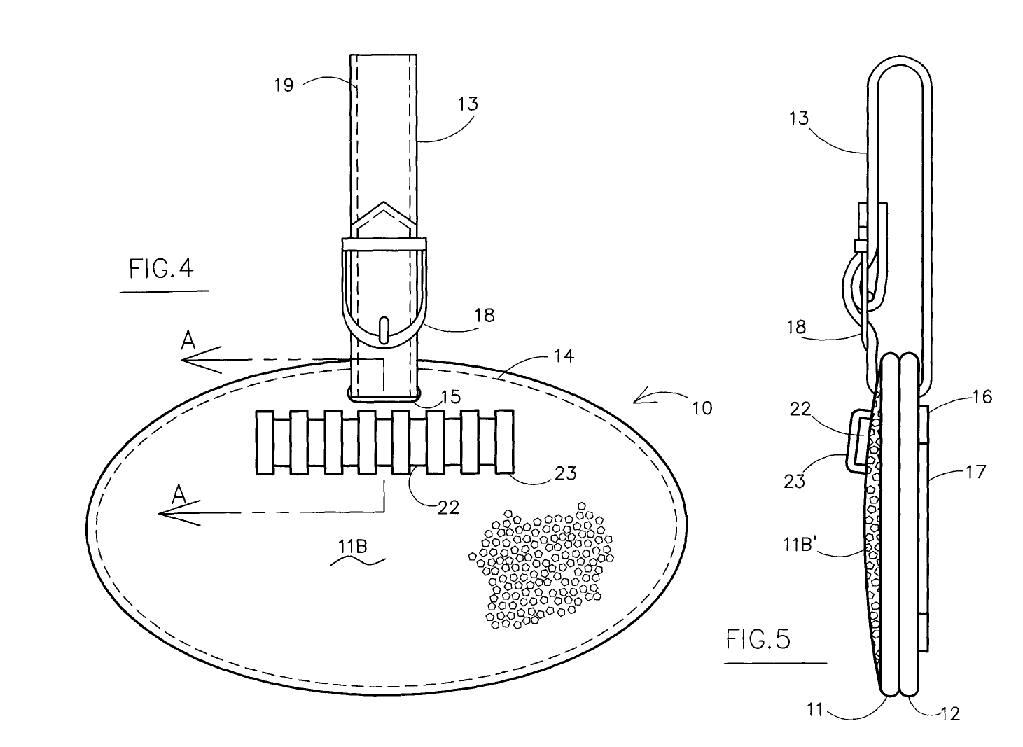

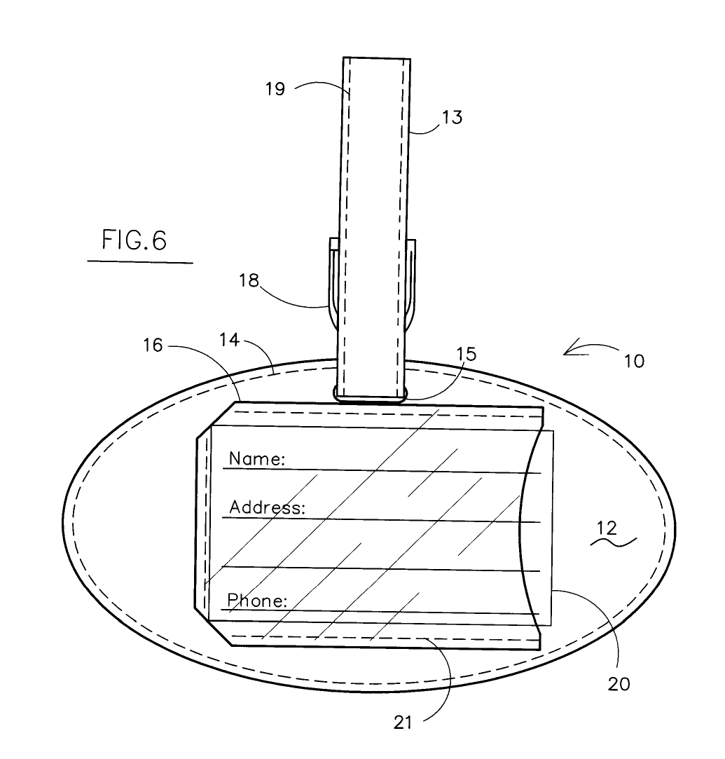

As seen in FIGS. 4 and 5, front panel 11B has surface indicia constructed and arranged to look and feel like a football, with a front shape that is nearly a prolated spheroid and having a textured leather, or leather-like, surface 11B′ and lacing 22 and 23.

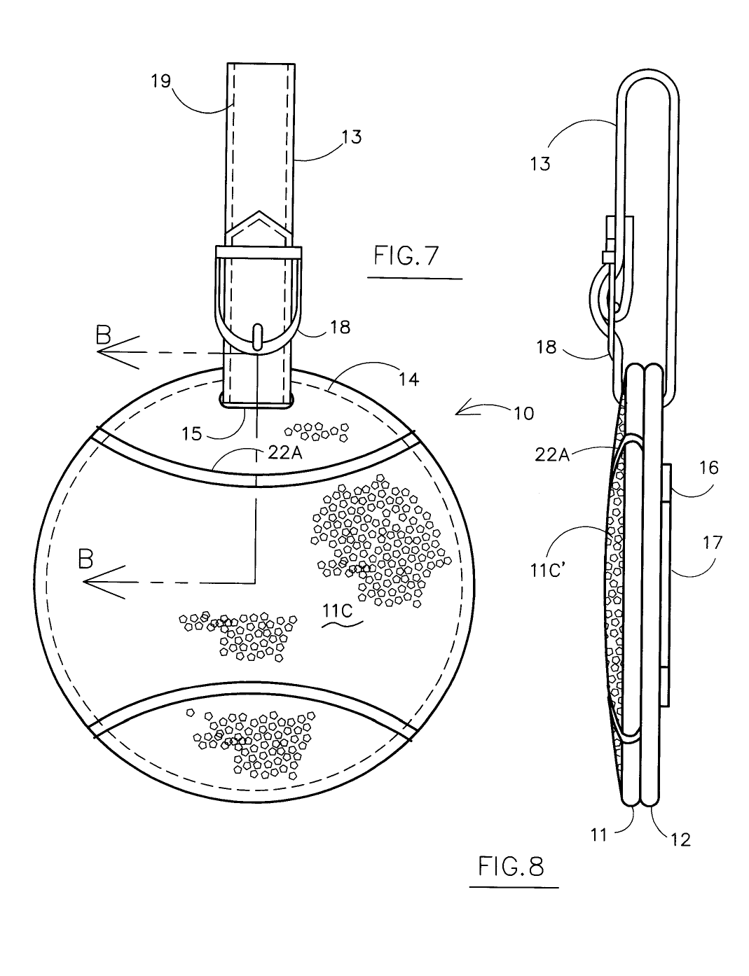

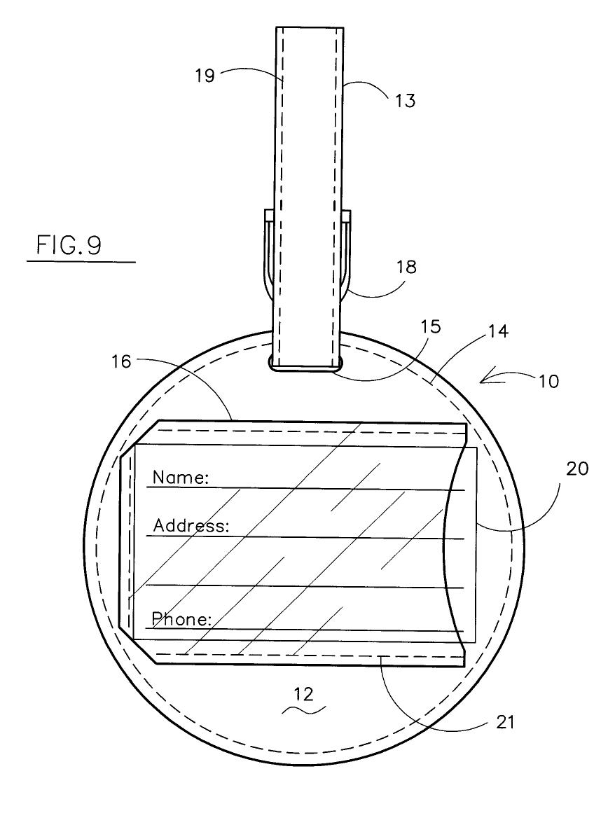

As seen in FIGS. 7 and 8, front panel 11C has surface indicia constructed and arranged to look and feel like a tennis ball, with a textured felt surface 11C′ and rubber seams 22A.

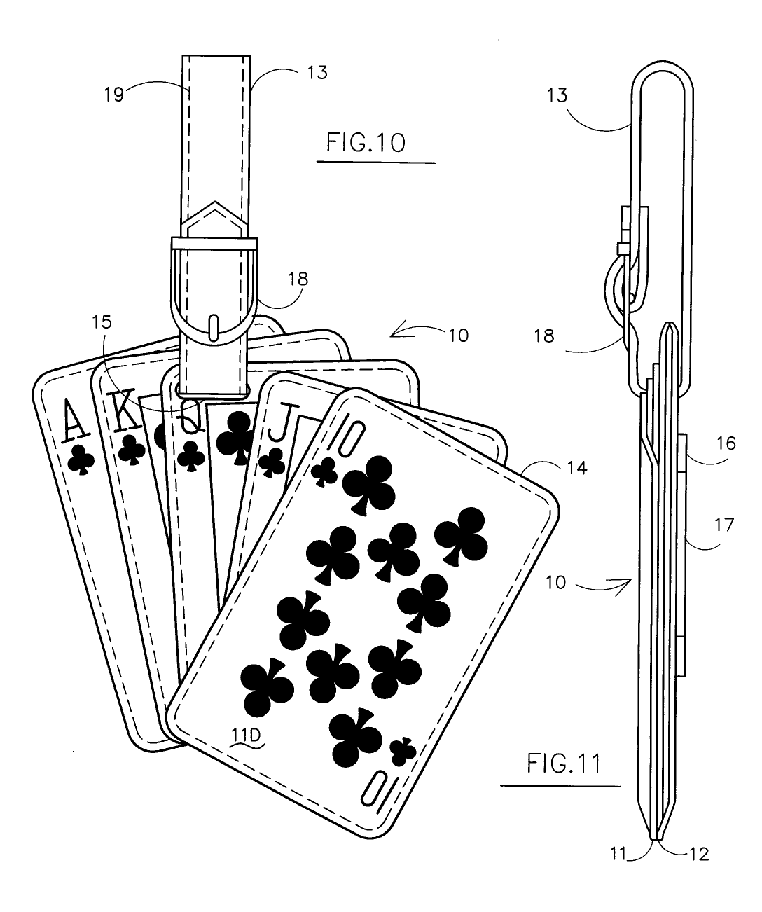

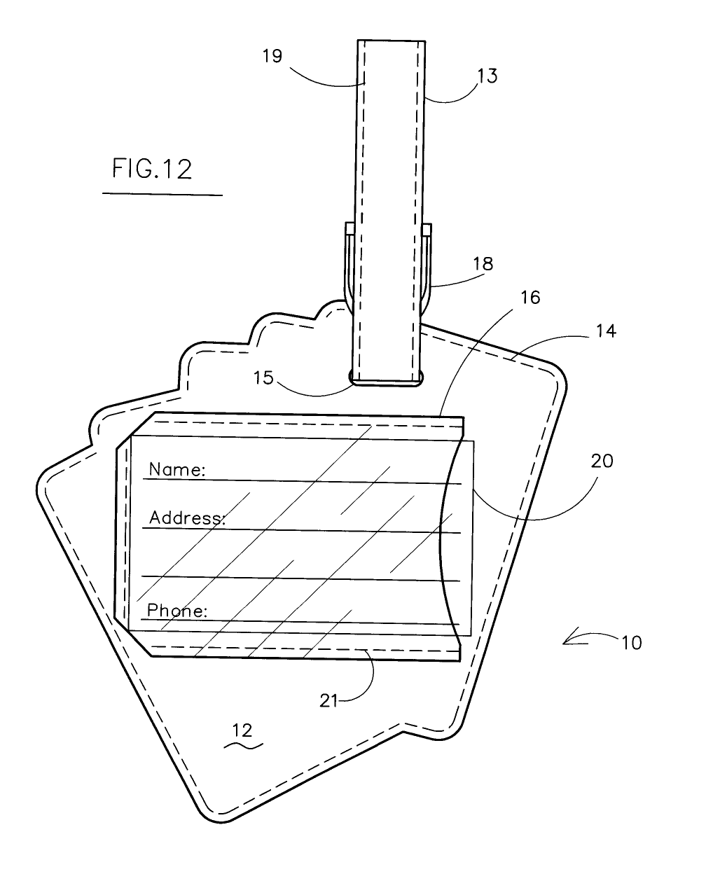

Luggage tag 10 may also have a front panel 11 constructed and arranged with surface indicia to imitate other articles. As seen in FIGS. 10 and 11, front panel 11D has surface indicia constructed and arranged to look and feel like a “hand” of playing cards, in a hand of a card game, and each individual card has peripheral stitching 14.

The surface indicia of front panel 11 and back panel 12 described herein may be constructed from an identical material of the article intended to be resembled, or of material closely resembling the look and feel of the article intended to be resembled. By way of example, the tennis ball luggage tag 10 of FIG. 7 may have actual tennis ball felt and actual rubber seams of a commercial tennis ball on the outer surface of front panel 11, or may be a material that closely resembles tennis ball felt and characteristic tennis ball seams. Likewise, the same is true for the luggage tag that resembles a baseball, basketball, football etc.

Tag 10 is constructed and arranged to be a facsimile of the shape of an article. Tag 10 is intended to mimic, with textured relief including visual and tactile imitations of the mimicked article depicted on front panel 11. Optionally, the surface indicia having textured relief may also be on back panel 12. Between front panel 11 and back panel 12 are interior components comprising a first rigid support 24, a second rigid support 25, and padding 26, which are each generally formed in substantially identical shape as front panel 11. The padding may be any acceptable padding such as polyurethane foam and the like. In a preferred embodiment, the padding or foam may be between about 2-8 mm thick, preferably about 5 mm thick. The rigid support may be any acceptable support that may be sized and shaped as needed and may include cardboard paperboard and the like. In a preferred embodiment, each of the rigid supports may be between about 1-6 mm thick. Each of front panel 11 and back panel 12 may be about 0.5-4 mm thick. The preferred embodiments are not intended to be limiting and the thickness may be varied as needed. Front panel 11 and back panel 12 are secured one to another by peripheral stitching 14.

Luggage tag 10 is constructed and arranged to imitate a specific article. In most configurations, the articles intended to be imitated, such as baseball, basketball, football, and tennis ball, are clearly three dimensional objects, even the several playing cards in FIGS. 10 and 11 are three dimensional e.g. the hand of cards are stacked and fanned on one another. Although luggage tag 10 is three dimensional, and has front panel 11, back panel 12, and a plurality of inner components, and a depth, luggage tag 10 is in a relatively planer configuration. The overall configuration is such that the visual look of luggage tag 10 is substantially flat in relation to the articles intended to be imitated. As used herein, substantially flat configuration is not intended to describe luggage tag 10 as two dimensional. Luggage tag 10 is relatively planer to each article it is intended to imitate. The three dimensional aspect of tag 10 also includes the indicia 11 of tag 10 such as football laces, baseball stitching, and the texture of the surface of luggage tag 10 on front panel 11.

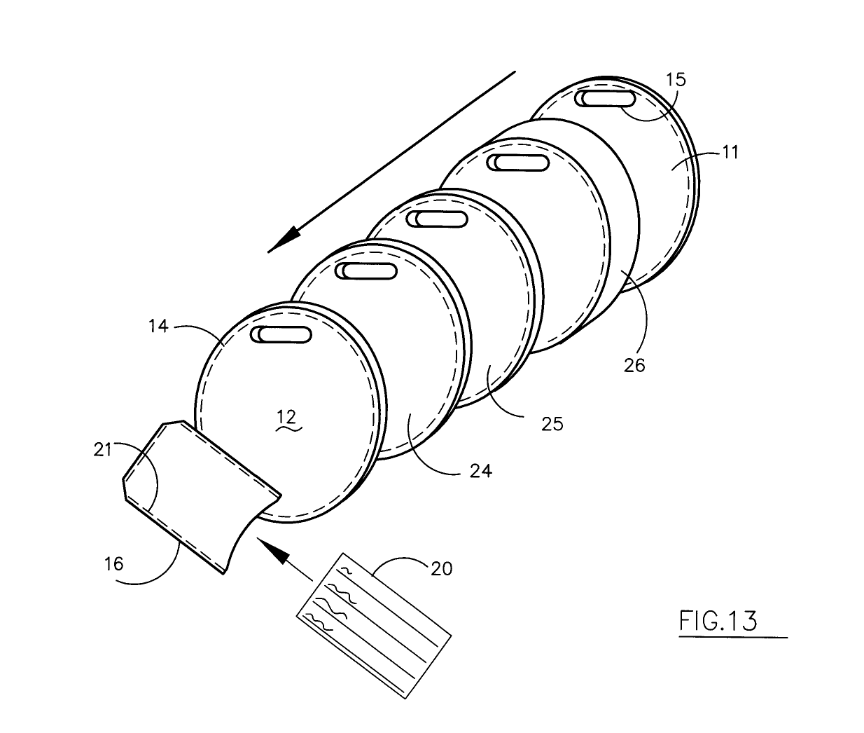

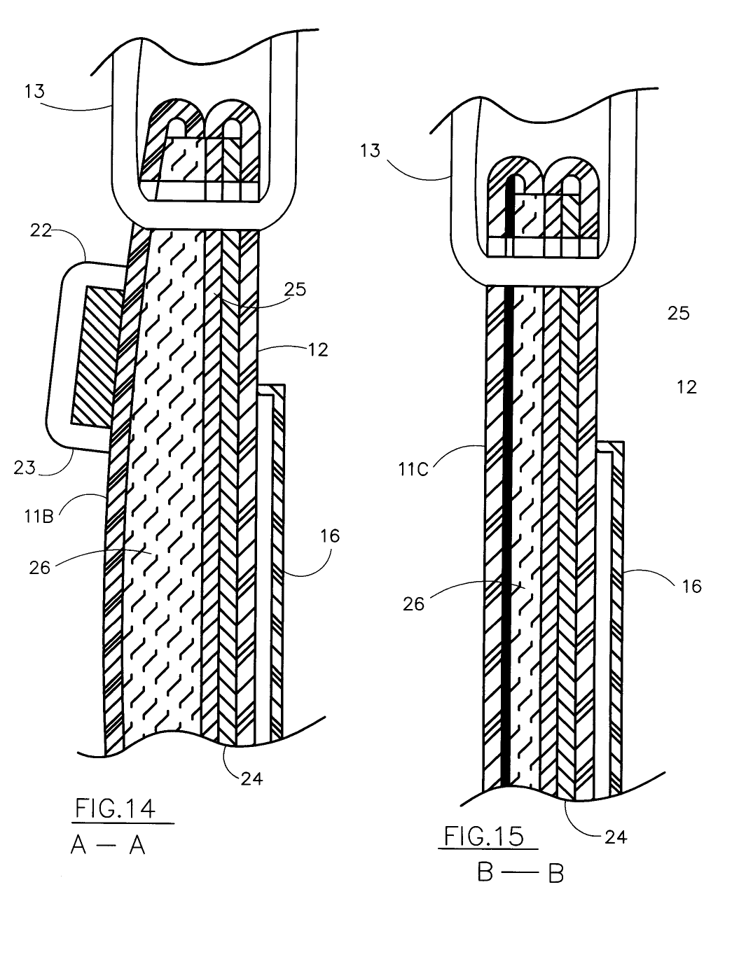

As stated above, display compartment 16 is on the exposed outer side of back panel 12 and encloses a display compartment cavity 17. Display compartment 16 is attached to back panel 12 by display compartment stitching 21. Display compartment stitching 21 encompasses a portion of the periphery of display compartment but not the entire periphery. The portion of display compartment 16 not having stitching allows for insertion of identification card 20 into display compartment cavity 17 as indicated by arrows next to identification card 20 in FIGS. 13 and 14.

Display compartment 16 may be formed of any transparent or substantially transparent material that may include, but would not be limited to plastics, organic films, inorganic films, and the like. In another embodiment, an identification tag may be secured directly to tag 10 with a suitable adhesive and would not need display compartment 16.

In other embodiments, tag 10 has front panel 11 formed of actual material used in the manufacture of articles from the sport of golf. Tag 10 is formed having front panel 11 of actual material used in the manufacture of the surface of golf balls. Additionally, tag 10 can be formed having a surface formed of actual material used in the manufacture of golf clubs such as use of actual golf club iron or wood materials.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A tag for providing identifying indicia comprising:
a. a front panel having an outer surface; whereby said outer surface comprises surface indicia features to realistically tactilely imitate an article, said indicia being formed of identical materials used in the manufacture of said article which said tag imitates;
b. a back panel having an outer surface;
c. a substantially transparent display compartment connected to said outer surface of said back panel suitable for holding and viewing a card with identifying information.

2. The article of claim 1 wherein said surface indicia on said outer surface of said front panel is formed of actual material used in the manufacture of the surface of a baseball, a basketball, a football, a tennis ball, golf ball, or golf club.

3. The article of claim 2 wherein said surface indicia on said baseball comprises actual material used in the manufacture of a baseball surface and baseball stitching to imitate look and feel of a baseball surface and baseball stitching.

4. The article of claim 2 wherein said surface indicia on said basketball comprises actual material used in the manufacture of a basketball surface to imitate look and feel of a basketball surface.

5. The article of claim 2 wherein said surface indicia on said football comprises actual material used in the manufacture of a football surface and football lacing to imitate look and feel of a football surface and football laces.

6. The article of claim 2 wherein said surface indicia on said tennis ball comprises actual tennis ball felt material used in the manufacture of a tennis ball to imitate look and feel of a tennis ball surface.

7. The article of claim 2 wherein said surface indicia on said golf ball comprises actual golf ball surface material used in the manufacture of a golf ball to imitate look and feel of a golf ball surface.

8. The article of claim 2 wherein said surface indicia on said golf club comprises actual golf club iron or wood material used in the manufacture of a golf club to imitate look and feel of a golf club.

9. The article of claim 1 wherein said front panel is attached to said back panel.

10. The article of claim 9 wherein said attachment is with threads stitched through the bodies of each of front panel and said back panel.

11. The article of claim 1 wherein said transparent pocket is connected to said back panel by stitching or adhesive.

12. The article of claim 1 wherein at least one additional material is constructed and arranged in substantially the same shape as said front panel and said back panel and placed therebetween.
